(19) United States
(12) Patent Application Publication
(10) Pub. No.: US 2017/0124640 A1
(43) Pub. Date: May 4, 2017

(54) MULTI-UNIT PRE-APPROVAL FOR RENTAL PROPERTIES

(71) Applicant: RentSafari.com, Inc., Everett, WA (US)

(72) Inventors: Kenneth A. Stumbo, Renton, WA (US); Noah Henry Hartkopf, Snohomish, WA (US)

(21) Appl. No.: 15/339,629

(22) Filed: Oct. 31, 2016

Related U.S. Application Data
(60) Provisional application No. 62/272,528, filed on Dec. 29, 2015.
(60) Provisional application No. 62/248,750, filed on Oct. 30, 2015.

(51) Int. Cl. G06Q 30/06; G06F 17/30

(52) U.S. Cl. CPC G06Q 30/0645; G06F 17/30424; G06F 17/30554

(57) ABSTRACT

A system and method for providing pre-approval of rental units enables a user to select multiple properties for which to apply for pre-approval. The system generates separate screening requests for each selected property based on personal information provided by the user and approval requirements specific to each selected property. The user is screened for each property in accordance with the approval requirements for that corresponding property. A unique identifier for the user is maintained and tracked so that a single credit or background check on the user is performed and results from those checks are used for multiple screening requests for different properties. The screening results are provided to the user along with an approval code for those properties for which the user is approved. A property can utilize the approval code to validate that the user is already approved for that property.

### BACKGROUND

Technical Field

The present disclosure pertains to providing pre-approval for the rental or lease of rental properties and, more particularly, to screening a prospective renter or lessee for a plurality of different properties based on the specific approval requirements of the different properties without pulling the user's credit for each separate screen.

Description of the Related Art

When looking for a new apartment to rent, a prospective renter or lessee (referred to herein as a “user”) often looks in the classified advertisements or other types of media to obtain a list of available apartment, condominium, townhouse or other similar rental properties. Once equipped with this list, the user travels to each separate property to inspect available units. If the user is interested in renting a particular unit, the rental property manager generally runs a background check on the user to see if they meet certain specific requirements that it is looking for in their tenants, such as criminal record, monthly income, credit check, etc. If the background check comes back negative, in that the user is not approved to rent the unit, then the user has to repeat this process at a different property until the user finds an available unit that they like and are approved to rent. All the while, every rental property loses time and money in showing a unit to a person who is not approved. Likewise, each rental property typically pulls the user's credit report, and too many credit checks can negatively impact the user's credit score or rating.

### BRIEF SUMMARY

In accordance with one aspect of the present disclosure, a system and method for providing pre-approval of a user for rental properties is provided. The system includes a screening computing system and a pre-approval aggregator computing system. The system queries a database for a plurality of available rental properties that match search criteria provided by the user. The system provides the plurality of available properties to the user. The user then selects one or more of these properties for which to apply for pre-approval. The system generates separate applications or screening requests for each of the selected properties based on personal information provided by the user and approval requirements specific to each selected property. A screening request is provided to the screening computing system along with each separate application and a unique identifier for the user. The user is screen for each property in accordance with the approval requirements for that corresponding property. The unique identifier enables the screening computing system to perform a credit or background check on the user and use results from those checks for multiple applications for different properties. Results from the screening request are provided to the user along with an approval code for those properties for which the user is approved. In some embodiments, the screening results identify those properties that the user is outright approved for and those properties that the user is conditionally approved for dependent on additional screening results. The user can then visit a property-of-interest and provide the property manager with the approval code. The property manager then sends the approval code to system to validate that the user is already approved for that property.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the following drawings, wherein:

FIG. 1 is a context diagram that illustrates an example of an implementation of an environment that provides pre-approval for a plurality of rental properties;

FIG. 2 is a logical flow diagram that illustrates one implementation of an overview process for providing pre-approval for a plurality of different available rental properties;

FIG. 3 is a logical flow diagram that illustrates one implementation of a process for performing a plurality of screens for a plurality of properties;

FIG. 4 is a logical flow diagram that illustrates one implementation of a process for validating that a user is pre-approved to a property-of-interest.

FIGS. 5A-5F illustrate different example use case screen shots of a user interface provided by a system that provides pre-approval of a plurality of different available rental properties in accordance with the present disclosure;

FIG. 6 is a logical flow diagram that illustrates one implementation of an alternative process for recommending other properties for which a potential renter is pre-approved;

FIGS. 7A-7B illustrate different example use case screen shots of a user interface provided by a system that recommends other properties for which a potential renter is pre-approved in accordance with the present disclosure; and

FIG. 8 is a system diagram of computing systems for implementation of the process and method of the present disclosure.

### DETAILED DESCRIPTION

In the following description, certain specific details are set forth in order to provide a thorough understanding of various disclosed implementations. However, one skilled in the relevant art will recognize that the present disclosed implementations may be practiced without one or more of these specific details or with other methods, components, materials, etc. In other instances, well-known structures or components or both that are associated with the environment of the present disclosure, including but not limited to the communication systems and networks, systems for advertising rental properties and checking credit, and documents related to leasing of property have not been shown or described in order to avoid unnecessarily obscuring descriptions of the implementations.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one implementation” or “an implementation” means that a particular feature, structure, or characteristic described in connection with the implementation is included in at least one implementation. Thus, the appearance of the phrases “in one implementation” or “in an implementation” in various places throughout the specification are not necessarily all referring to the same implementation.

The use of property or rental property herein refers to a dwelling that is offered or given for rent or lease. Although property is described herein in the context of apartment units, the term property is also to be construed to include and the disclosure to apply to, without limitation, apartments and apartment buildings and complexes, condominiums, town houses, twin homes, duplexes or other multiplex buildings, single family houses, mother-in-law houses, trailer homes, or other dwellings that can be rented or leased to others. An available property is a property that is currently up for rent or lease and in the process of acquiring new tenants.

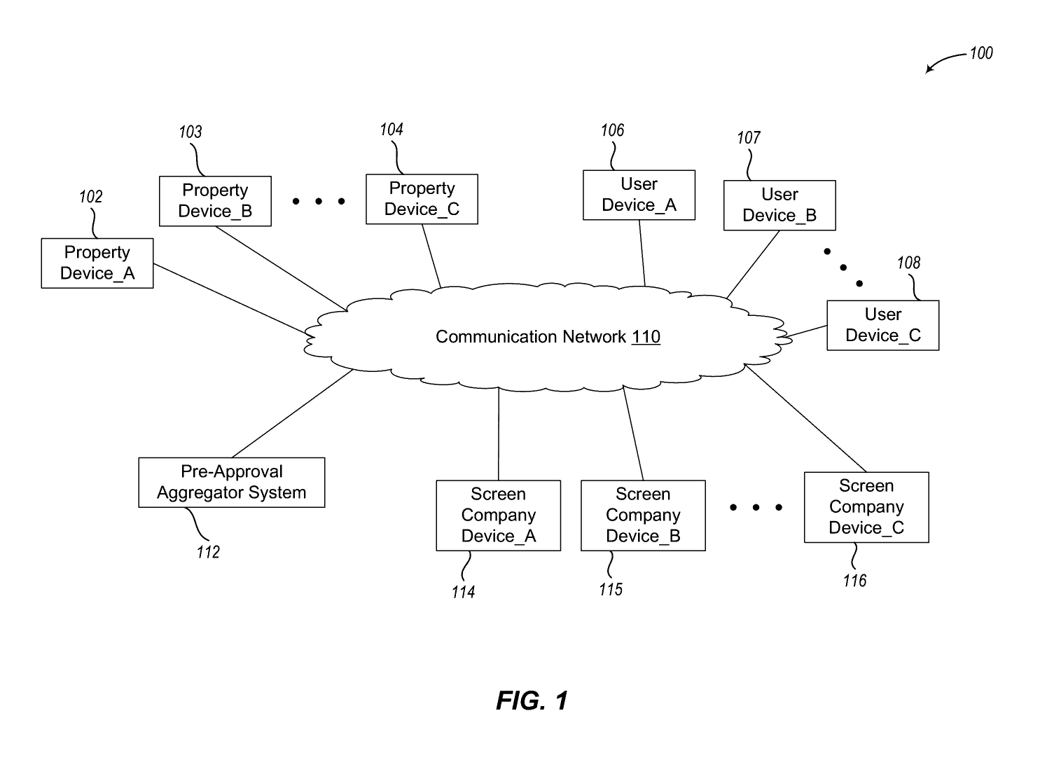

FIG. 1 is a context diagram that illustrates an example of an implementation of an environment 100 that provides pre-approval for a plurality of rental properties. The environment 100 includes a plurality of property devices 102-104 (associated with a plurality of different available properties), a plurality of user devices 106-108 (associated with a plurality of different users), a plurality of screening company devices 114-116 (associated with a plurality of different screening companies), and a pre-approval aggregator system 112 that communicates with the other devices via a communication network 110.

The property devices 102-104, the user devices 106-108, the screening company devices 114-116, and the pre-approval aggregator system 112 may be implemented through various computing devices. For example, the property devices 102-104 and the user devices 106-108 may utilize various client devices, such as mobile phones, tablets, desktop computers, laptop computers, or the like to access the pre-approval aggregator system 112. And the pre-approval aggregator system 112 and the screening company devices 114-116 may utilize various server devices that are known in the art and will not be described in detail herein. The communication network 110 may include one or more wired or wireless networks that are configured to couple various computing devices to transmit content/data from one or more devices to one or more other devices.

As an example, a user of the user device 106 can access a user interface provided by the pre-approval aggregator system 112 to apply for pre-approval for a plurality of different properties. For example, using the user device 106, the user queries the pre-approval aggregator system 112 for available properties that match some search criteria. From the results of the query, the user selects one or more properties to apply to for pre-approval.

The user provides various personal information through the user interface to the pre-approval aggregator system 112, which generates a rental pre-approval application for the user from the provided information. This user information may include the user's name, date of birth, salary, social security number, or other information that is used in the screening process of renters. In response to generating the application, the pre-approval aggregator system 112 runs a credit check, background check, or obtains other personal history metrics associated with the user. This obtained information and the information provided in the application may be referred to as the screening information for the user. As described herein, each separate property has separate screening requirements—as a result, some of the screening information may be used in the screening process of the user for some properties but not for others. In some implementations, the pre-approval aggregator system 112 may not obtain some screening information if none of the selected properties include it as a requirement. For example, if none of the properties require a criminal history check, then the pre-approval aggregator system 112 does not request one.

The pre-approval aggregator system 112 generates a separate screening request for each separate selected property. Each screening request is uniquely generated for each separate property based on the specific screening requirements or criteria for the corresponding property. The pre-approval aggregator system 112 compares the screening information to the specific screening requirements for each separate selected property to separately determine if the user is pre-approved for each selected property.

In some implementations, a property may request or require that the pre-approval aggregator system 112 use a screening company to perform its screen to pre-approve users. The pre-approval aggregator system 112 then provides those screening requests to one or more of the screening company devices 114-116 to perform a screen of the user for the corresponding selected property. The screening company that performs the screening provides the results to the pre-approval aggregator system 112.

In response to the pre-approval aggregator system 112 pre-approving the user for at least one of the selected properties—or a screening company returning a pre-approval result—the pre-approval aggregator system 112 provides the results along with an approval code to the user via the user device 106.

The user can then go to a property-of-interest (e.g., the property associated with the property device 102) and provide the approval code to a representative of the property-of-interest. The property-of-interest utilizes the property device 102 to provide the approval code to the pre-approval aggregator system 112 to determine if the approval code is valid for the property-of-interest, i.e., the user is approved for the property-of-interest. If the approval code is valid, the pre-approval aggregator system 112 provides an approval indication to the property device 102.

If the user chooses to move in to the property-of-interest, the property device 102 sends a notification to the pre-approval aggregator system 112, which then generates and prepopulates the necessary rental agreement documents and provides them to the property device 102.

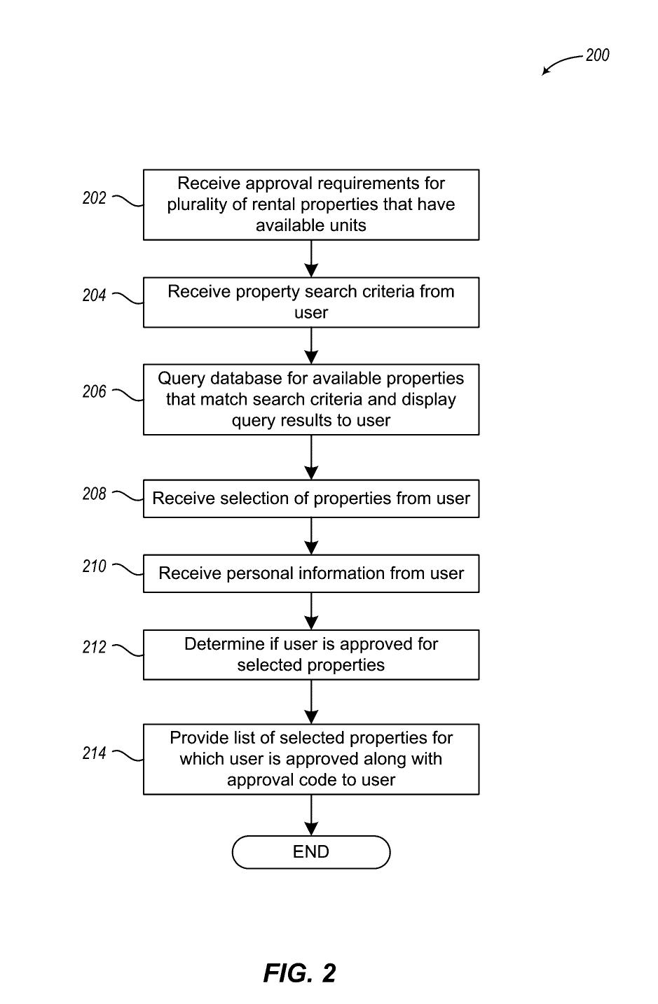

FIG. 2 is a logical flow diagram that illustrates one implementation of an overview process for providing pre-approval for a plurality of different available rental properties. A user that is pre-approved for an available rental property refers to a rental applicant who applies for and is approved for a particular property prior to visiting, contacting or otherwise providing information to that property.

A process 200 begins at block 202, where approval requirements are received for a plurality of rental properties that have available units for rent. These rental properties are referred to herein as available properties. Each available property provides a list of requirements or criteria that it considers when deciding whether or not to approve a rental applicant for a rental unit. Each separate property provides a specific list of requirements, which can be different from one property to another. These requirements are often the contents of a rental application for the property. Example requirements may include a minimum credit score, a minimum monthly income, no criminal record, etc. Requirements can be verified through a variety of checking mechanisms, including background checks, credit checks, or other techniques to verify and approve an applicant

The process 200 proceeds to block 204, where property search criteria are received from a user. The user can access a website, mobile application, or other user interface to provide one or more criteria in which to search for apartments. Examples of search criteria include a city or neighborhood, a number of bedrooms, a number of bathrooms, whether pets are allowed, minimum or maximum rent, etc.

The process 200 continues at block 206, where, in response to receipt of the search criteria, a database of available properties is queried for properties that match the search criteria. The results from the query are then displayed to the user via the user interface.

After the results are displayed, the process 200 proceeds next to block 208, where a selection of one or more properties is received from the user. The user can utilize the user interface to select properties from the available properties that were displayed to the user in response to the query. In some implementations, a user may first mark those available properties that they are interested in, which are then added to a rental dashboard. The rental dashboard allows for the user to select properties to apply.

At block 210, personal information of the user is received. The user can enter this information through the user interface. In some implementations, the user creates an account that stores their personal information. The personal information includes information that may be needed for different screening processes for different available properties based on the approval requirements provided by the properties.

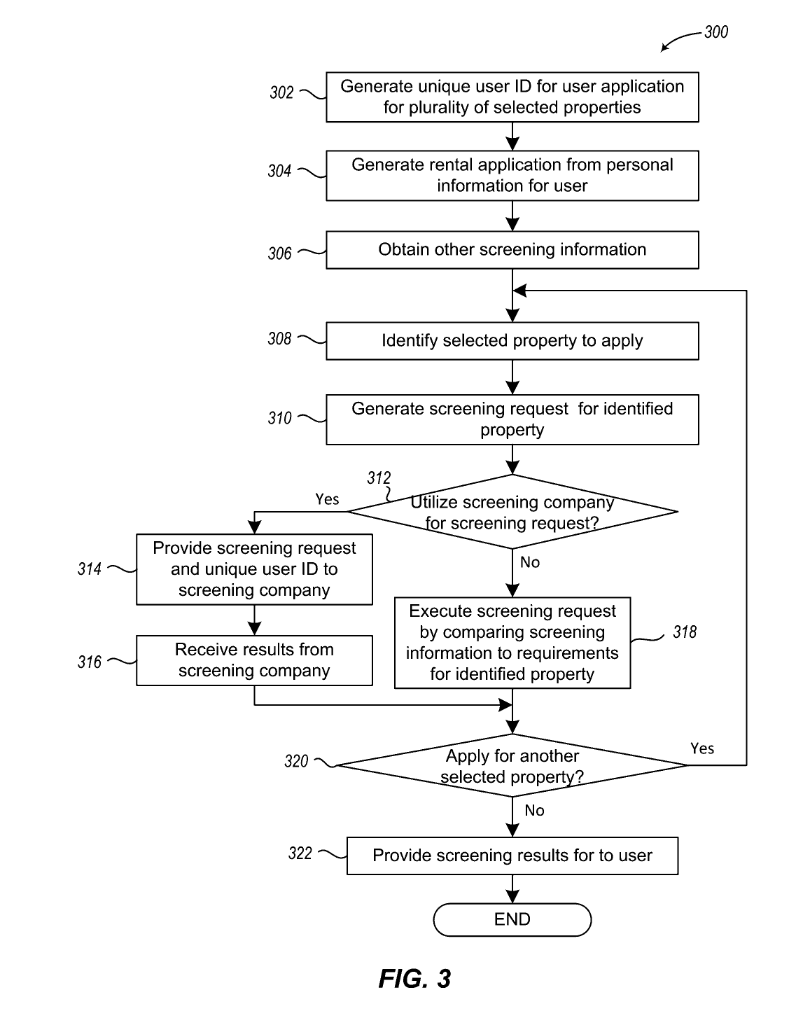

The process proceeds to block 212, where the system determines whether or not the user is approved for the selected properties, which is described in more detail below in conjunction with FIG. 3. Briefly, however, an application is generated from the personal information from received from the user. The system obtains other screening information as needed to complete the screening process.

One or more screening requests are generated for each selected property based on the approval requirements for that property and the personal information. In some implementations, the screening requests are executed by the system by comparing the screening information against the screening requirements for each selected property to determine if the user is approved, not approved, or conditionally approved (such as if the user meets most of the property's approval requirements but is awaiting a background check, which may take several days), for each selected property. In other implementations, one or more screening requests are provided to a property-approved screener that returns a report of whether the user is approved, not approved, or conditionally approved for the one or more selected properties.

In various implementations, the user is charged a single fee for applying to the plurality of selected properties. In this way, the user does not have to pay multiple rental application fees at different properties.

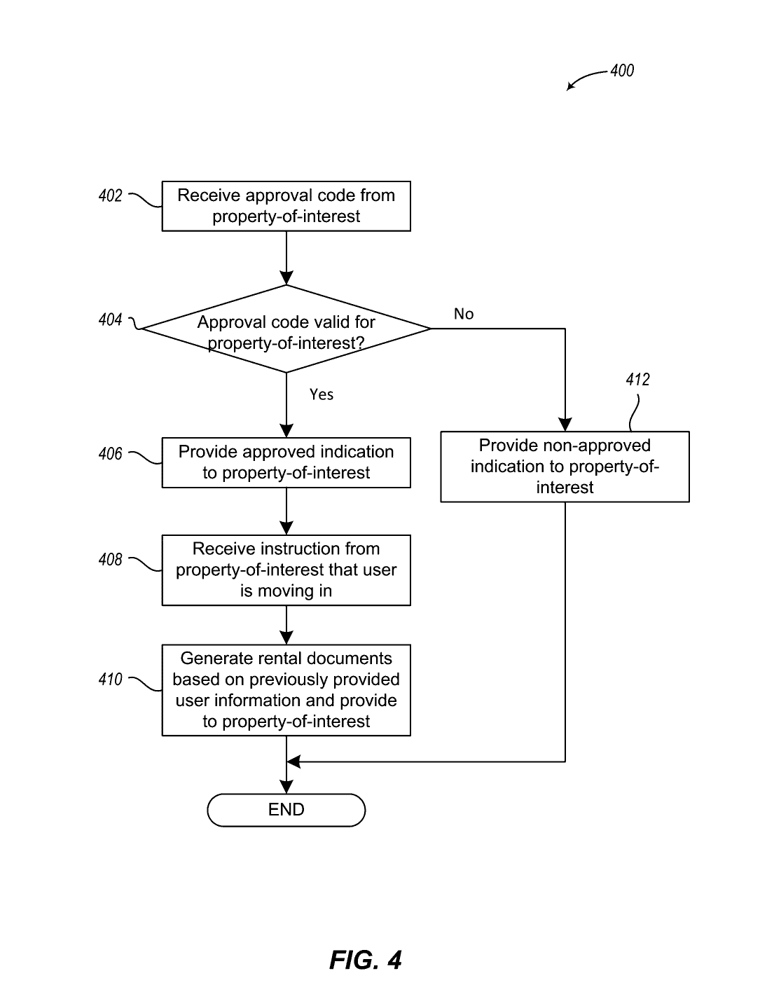

At block 214, a list of the selected properties for which the user is approved, conditionally approved, or not approved is displayed to the user. Along with the list of approved properties, an approval code is also provided to the user. This code is used by the properties to verify that the user is approved to rent from that particular property, which is discussed in more detail below in conjunction with FIG. 4.

In some implementations additional information may also be provided to the user. For example, for those properties where the user is not approved, the user interface may display one or more reasons why the user was not approved, or may include instructions on how to become approved. In another example, the approved properties may include a list of items that the user must bring to the property to finalize a rental agreement, such as government issued identification, first month's rent, references, etc. In at least one implementation, the user is enabled to set appointments with the properties for which they are approved.

The user interface can have shared access to a calendar with the properties and show availability to the user. The user can select an appointment time, which is then synchronized on the property calendar by populating the property calendar with the selected appointment time. By synchronizing the property calendar with the user interface, the user is provided real-time scheduling access to pre-approved properties, which allows the user to schedule appointments at multiple pre-approved properties without having to contact each individually property. Similarly, the sales representatives of the properties are not burdened with setting up appointments and can spend their time showing the property or performing other sales or property-management tasks. This additional feature may require the property to pay an additional fee.

Another feature that the property may pay for is a follow-up feature where the system contacts the user by phone, email, text message, or other communication to schedule an appointment, discuss amenities, or provide incentives to the user to come visit the property. For example, an SMS message is automatically sent to the user at some predetermined time after the user is pre-approved for one or more properties. The message includes one or more proposed appointment times for a property, along with additional information for the property, such as the applicable school district, local shopping and dining, pictures of the property, a map of the area surrounding the property, rent pricing, and move-in specials. If the user responds to the communication with a selected appointment time, the system automatically populates the calendar for the corresponding property as if the user directly selected the appointment time from the user interface (or an administrator of the system and unaffiliated with the property can input the appointment on the property calendar). The user may respond to the communication by sending a return message (e.g., return email or text message) with the selected appointment time or by selecting a corresponding link for the selected appointment time. In some implementations, selecting the link may take the user to a webpage with the property calendar or additional information about the property.

In another implementation, the user interface may indicate how many other users have been approved for a property, which may help drive users to the property in order to visit and rent an available unit before other approved users visit the property.

In some implementations, if the user is conditionally approved for one or more properties, the system may send the user a notification once that approval process is complete, i.e., the conditional approval is now approved or not approved.

After block 214, the process 200 terminates or otherwise returns to a calling process to perform other actions.

As described above, the pre-approval aggregator system may provide follow-up functionality and provide real-time synchronization of property calendars or appointment scheduling systems for pre-approved properties. In some implementations, the follow-up and appointment scheduling may occur prior to a user being pre-approved for a property, which may be available for another fee to the property. For example, a property may obtain a lead for a potential renter from a third party, such as a rental listing website. The property may provide the lead information to the pre-approval aggregator system, which can follow up on the lead with the potential renter. As described herein, the system can schedule an appointment in the property's calendar for the potential renter to visit the property. During the follow up, the potential renter can request pre-approval for the property and provide sufficient personal information for the pre-approval process. The pre-approval aggregator system performs the pre-approval process, and, if pre-approved, provides the approval code to the potential renter, as described herein.

FIG. 3 is a logical flow diagram that illustrates one implementation of a process for performing a plurality of screening steps for a plurality of properties. A process 300 begins at block 302, where a unique user identifier is generated. This unique user identifier is utilized to track the pre-approval process for different properties for the user. In this way, screening companies can perform a single credit or background check and utilize those results for the different properties. Traditionally, each separate property sends rental applications to a screening company and the screening company runs a separate credit check or background check for each separate application, which can get expensive and wasteful to the user, property, screening company. Similarly, multiple checks can impact the user's credit score or other metrics.

The process 300 proceeds to block 304, where a rental application is generated from personal information for the user. The personal information for the user may be provided by the user through a user interface, which is described in conjunction with block 210 of FIG. 2.

The process 300 continues at block 306, where other screening information is obtained. The other screening information may include results from a credit check, background check, or other personal history metric associated with the user. In various implementations, the other screening information may include a plurality of additional personal information or personal history that may be utilized by a rental property to screen potential renters, which may be determined from the requirements provided by the plurality of rental properties at block 202 in FIG. 2.

Process 300 proceeds to block 308, where one of the selected properties is identified for which to apply for pre-approval. In various implementations, each selected property may be individually identified at block 308 so that process 300 loops for each selected property and the user is screened against the specific requirements of each selected property. In other implementations, a plurality of the selected properties may be identified, such as if multiple selected properties have the same screening requirements.

The process 300 continues at block 310, where a screening request is generated from the rental application for the identified property. In some implementations, the screening request is generated based on the approval requirements of the identified property, which were provided at block 202 of FIG. 2, and the user-provided personal information. In at least one implementation, the screening request may include at least a portion of the other screening information obtained at block 306. For example, a credit score and the credit reporting company utilized may be included in the screening request.

Because each property may require different information for approval, separate screening requests are generated for each identified property. In some implementations, however, where requirements overlap between multiple properties, a single screening request or portions of a screening request may be generated and utilized for multiple properties.

Process 300 continues at decision block 312, where a determination is made as to whether a third party screening company is utilized to process the screening request for the identified property. In some implementations, the property preselects which screening company is to be used. In other implementations, a single screening company is used for all screening actions. If a screening company is utilized, process 300 flows to block 314; otherwise, process 300 flows to block 318.

At block 314, the screening request for the identified property and the unique user identifier are provided to the screening company. At this point, the screening company performs the corresponding screen of the user to determine if the user is approved or not for the selected property. Since each screening request includes the unique user identifier, the screening company can track multiple requests for a single user, which can allow the screening company to perform only a single background or credit check for use in multiple separate screening requests for a plurality of different properties.

The process proceeds to block 316, where a report with approval results is received from the screening company. As described elsewhere, this report may indicate whether the user is approved, not approved, conditionally approved (pending additional checks or waiting for results from checks that take time to complete), information why a user was not approved, a list of items to bring to the property to finalize a rental agreement, or the like. After block 316, the process 300 flows to decision block 320.

If, at decision block 312, a third party screening company is not used, then the process 300 flows from decision block 312 to block 318. At block 318, the screening request is executed by the system and the screening information is compared with the specific requirements for the identified property to determine if the user is pre-approved for the property. A report is generated from the screening results, which indicates if the user is approved, not approved, or conditionally approved, and may include other information, such as why the user was not approved, a list of items to bring to the property to finalize a rental agreement, or a calendar that the user can utilize to schedule an appointment to view the property. After block 318, process 300 flows to decision block 320.

At block 320, a determination is made about whether the user is applying for another selected property. If the user is applying for another property, then the process 300 loops to block 308 to identify another selected property; otherwise, the process 300 continues to block 322.

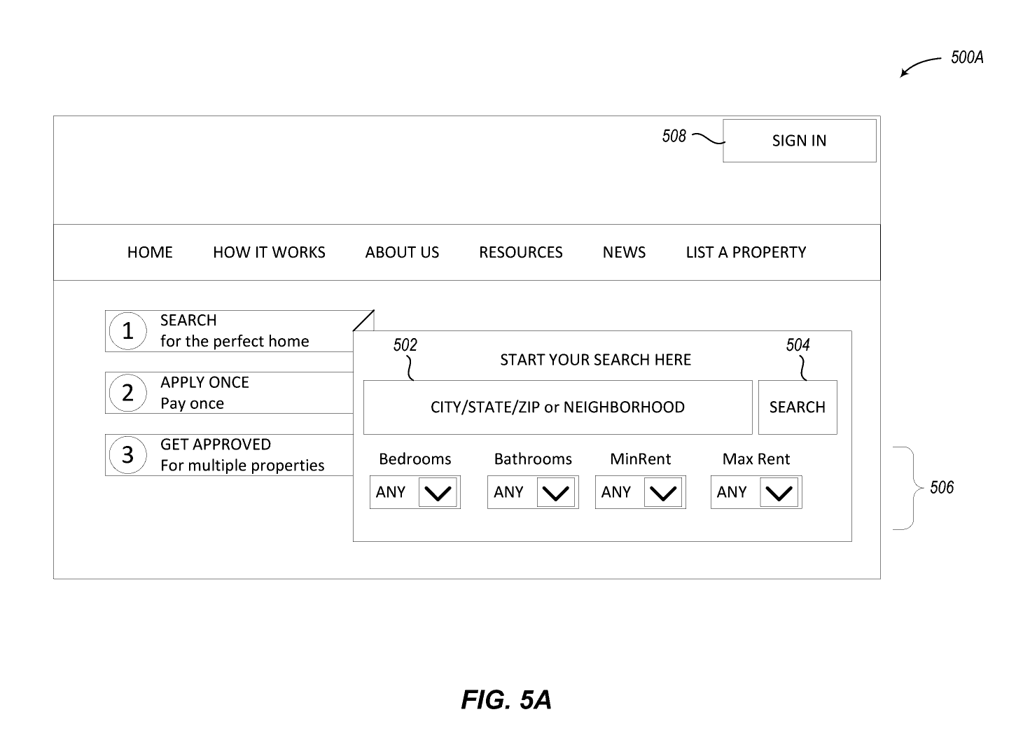

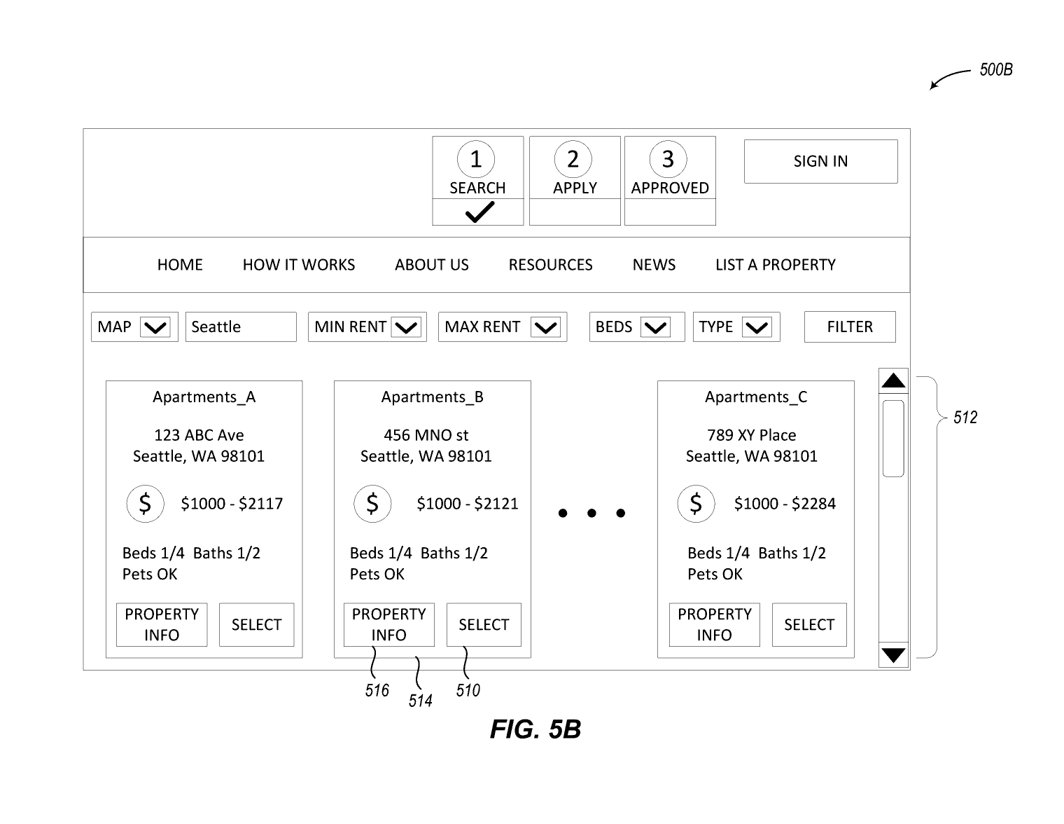

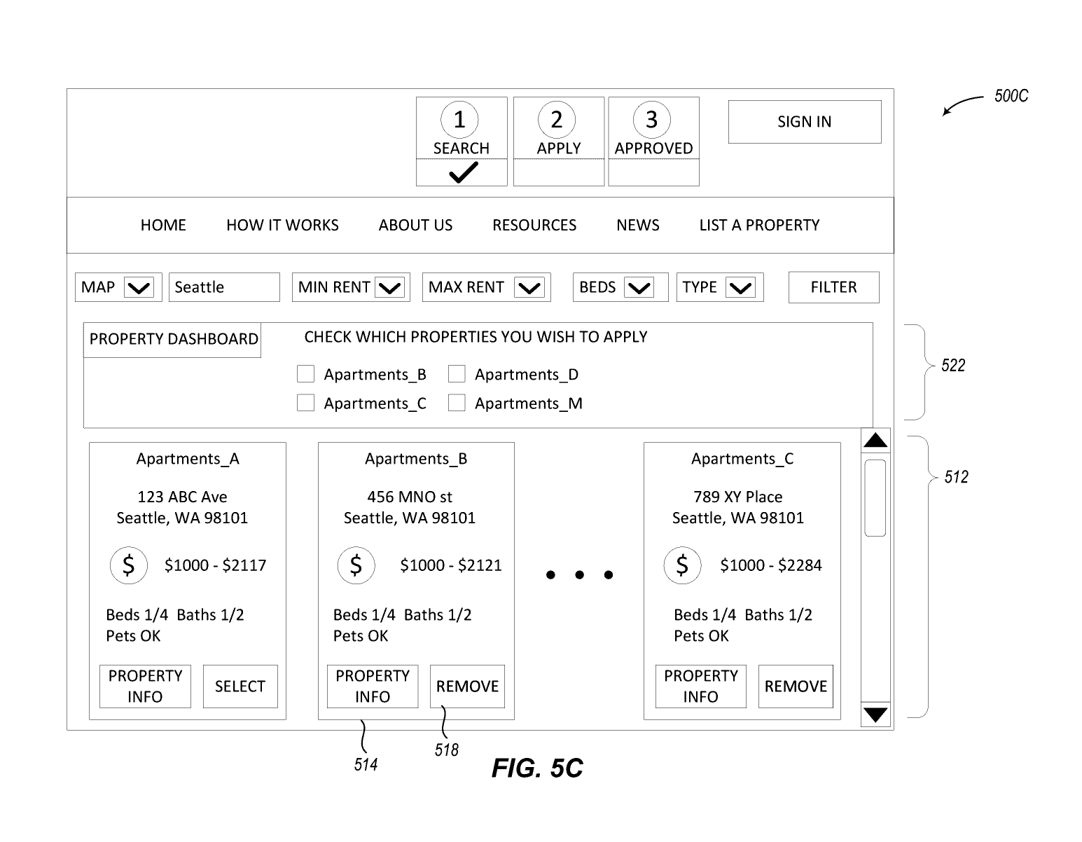

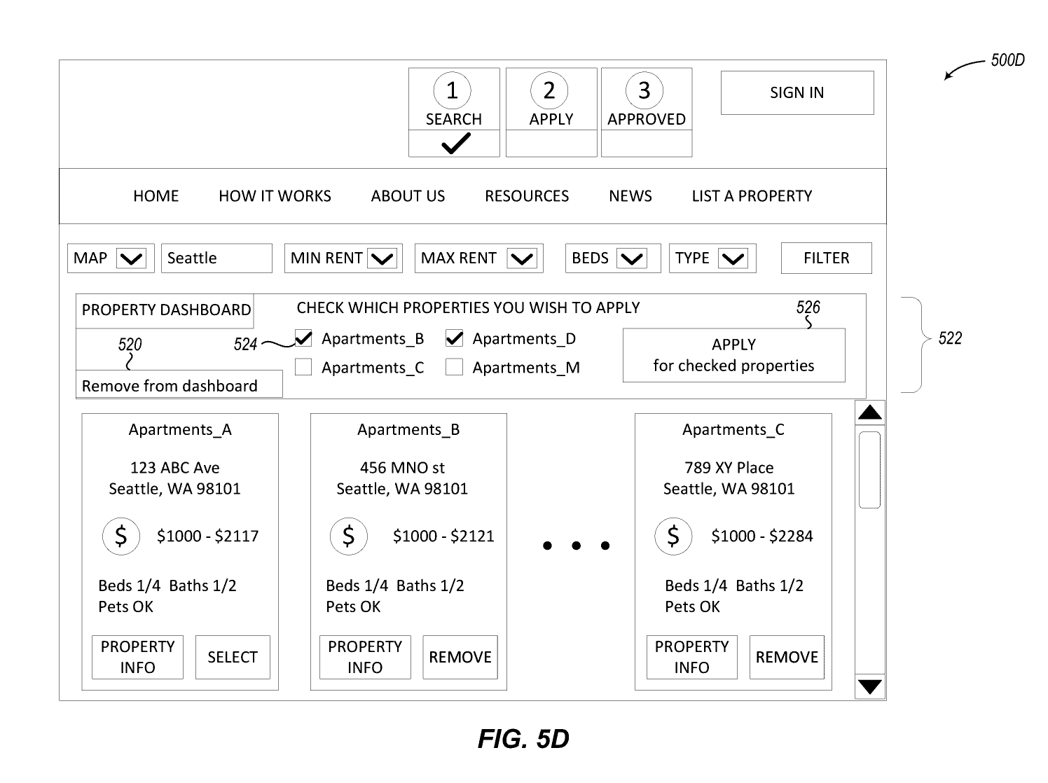

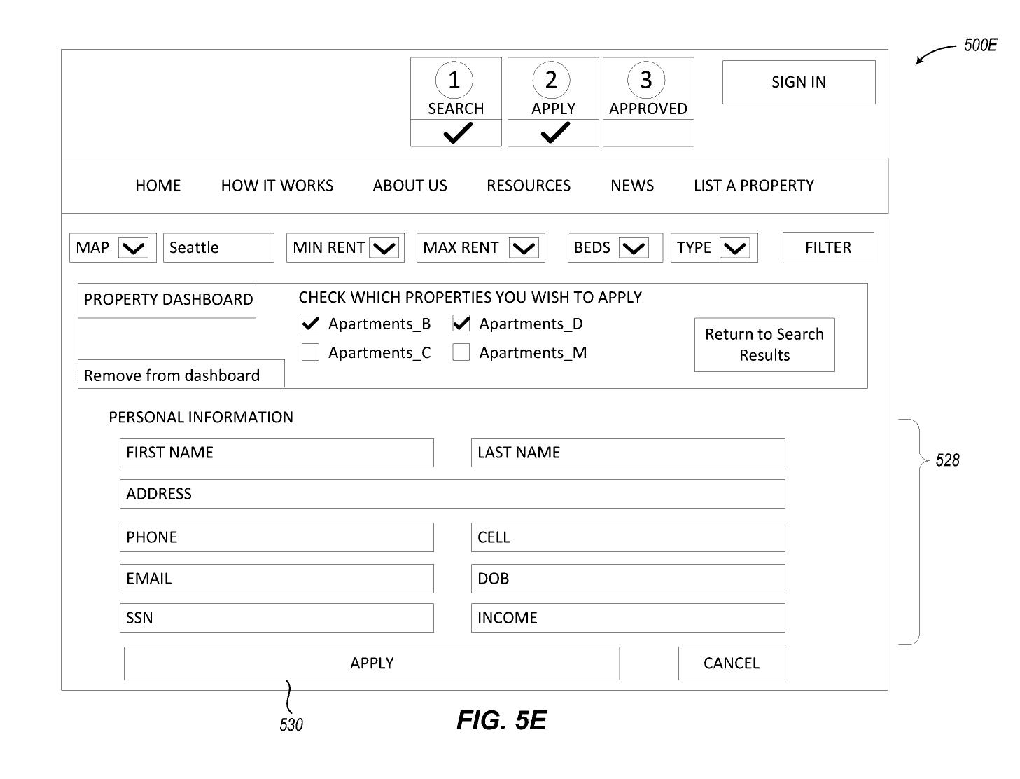

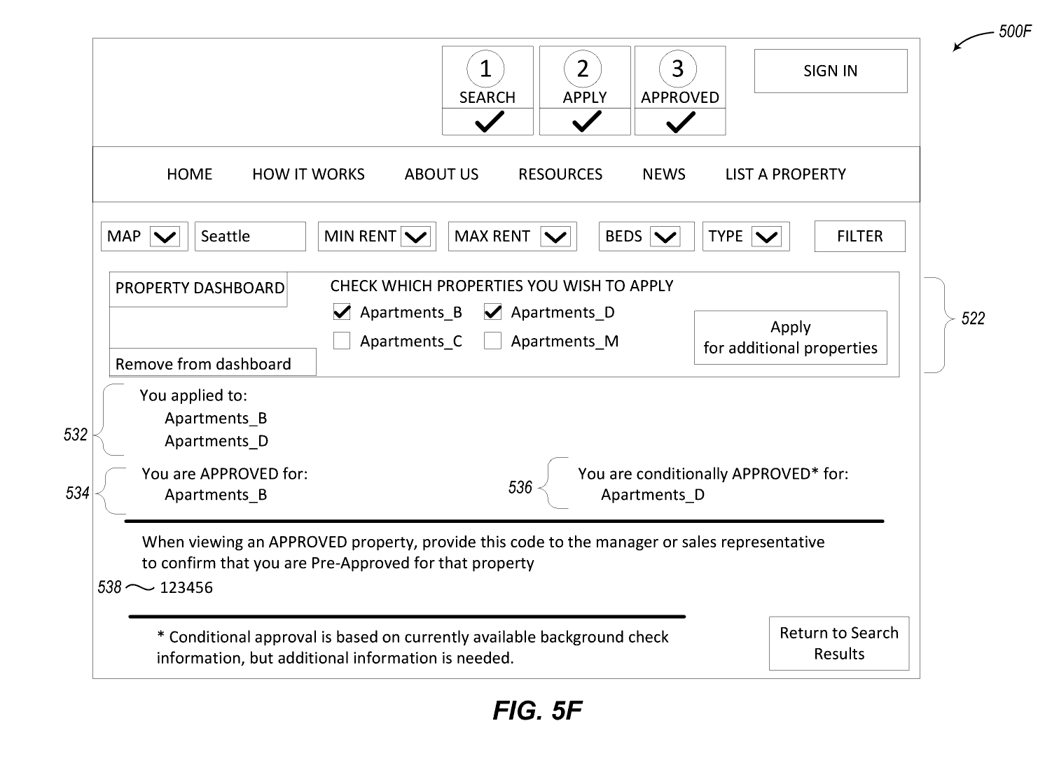

At block 322, the screening results are provided to the user. In some implementations, the results include an aggregated report for each selected property, such as shown in FIG. 5F. After block 322, the process 300 terminates or otherwise returns to a calling process to perform other actions. It should be recognized that the foregoing processes 200 and 300 can be performed prior to the user ever visiting any property. In this way, the user does not waste their time going to a property for which they are not approved. Similarly, sales representatives at the properties do not waste their time by showing rental units to potential tenants that do not qualify to rent from that property.

FIG. 4 is a logical flow diagram that illustrates one implementation of a process for validating that a user is pre-approved to a property-of-interest. A process 400 begins at block 402, where an approval code is received from a property-of-interest. When a user arrives at a property that they wish to rent, i.e., the property-of-interest, the user provides to the property representative or manager the approval code that they previously received. The property representative can then access the system and use the approval code to determine if the user is pre-approved for the property-of-interest.

The process 400 proceeds to decision block 404, where a determination is made as to whether the approval code is valid for the property-of-interest. The approval code is valid for the property-of-interest if the user has already been approved for the property-of-interest. If the approval code is valid, the process 400 proceeds to block 406, otherwise, the process 400 proceeds to block 412.

At block 406, the pre-approval aggregator system 112 sends an approved indication to the property-of-interest. At this point, the manager of the property-of-interest knows that the user is pre-approved and can progress to show them available units at the property.

If the user likes the property-of-interest and wants to rent the unit, then the property-of-interest sends an instruction to the system indicating such a request. The system receives the instruction at block 408. Once the system receives this instruction, the properties charge a fee for using the system. In some implementations, a property may also pay an upfront fee to use the system's efficient and seamless way of attracting pre-approved tenants.

The process 400 proceeds next to block 410 where rental documents are generated and prepopulated based on the previously provided personal information of the user. The system then provides the rental documents to the manager of the property-of-interest. In this way, the user can sign the rental documents immediately without having to wait for a sales representative to manually generate the documents. After block 410, the process 400 terminates or otherwise returns to a calling process to perform other actions.

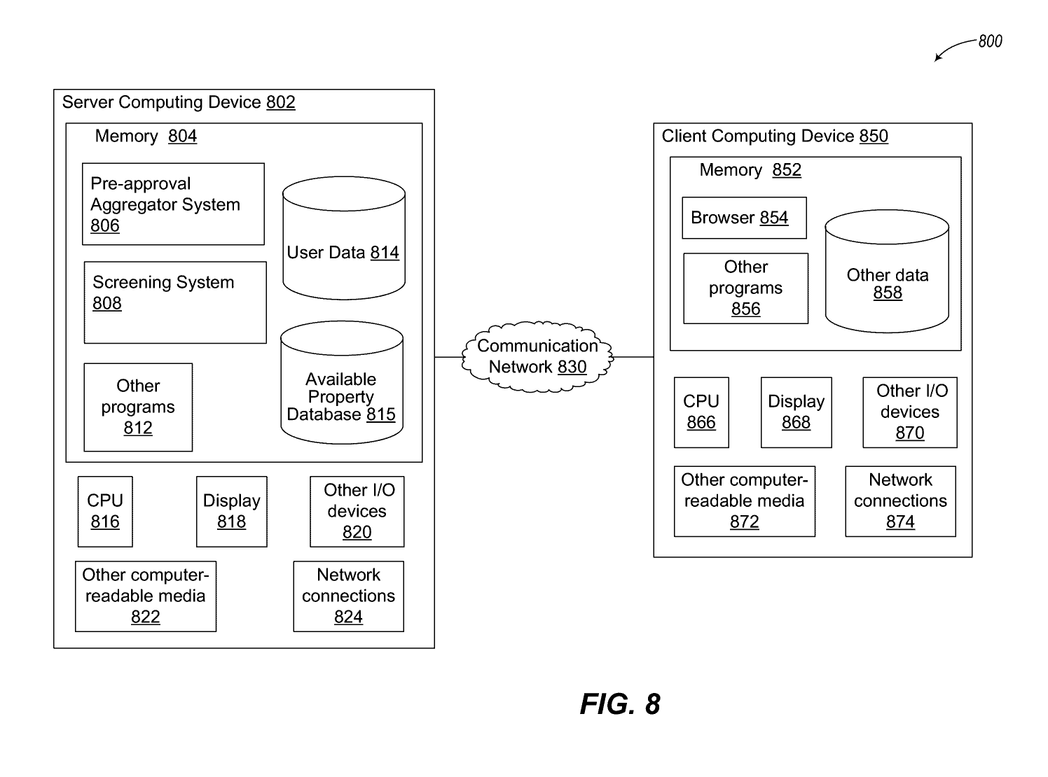

In various implementations, at least portions of the foregoing processes 200, 300, or 400 of FIGS. 2, 3, and 4, respectively, are performed by hardware circuits of a pre-approval aggregator system. One implementation of the computing systems that employ such hardware circuits is depicted in FIG. 8.

FIGS. 5A-5F illustrate various example use case screen shots of a user interface provided by a system that provides pre-approval of a plurality of different available rental properties in accordance with the present disclosure. A user interface 500A illustrated in FIG. 5A enables a user to input search criteria. For example, the user can enter a particular city or neighborhood into a text input box 502. The user can further refine their search by providing additional criteria through other inputs 506. Once the user has provided their search criteria, they can begin the search by pressing a search button 504. In some implementations, the user can click on a sign-in button 508 to be taken to an interface where the user can log in to provide or access previously provided information, previous searches, previously approved apartments, etc.

After the user presses or otherwise activates the search button 504, the system accesses a database of available properties to determine which properties match the user's criteria.

A user interface 500B illustrated in FIG. 5B displays the results of the available property query. In this example, a plurality of results 512 are displayed to the user. Each property listing in the results 512 may include a variety of different information regarding that particular property, such as the name, address, rent amounts, number of bedrooms or bathrooms in available units, etc. The listings can be for individual available rental units or for properties with multiple available units. The display can be via a visual device, such as a monitor, or it may be in printed form. Alternatively it may be communicated audibly or it may be both audible and visual. Other known means of communication may also be used, such as sign language, Braille, etc.

Each listing can also include a button to access additional information regarding that particular property. For example, a property listing 514 includes an information button 516, which when clicked by the user opens another display with more information about “Apartments_B.” Each property listing also includes a select button for the user to add to a property dashboard to apply for pre-approval. For example, the property listing 514 include a button 510 that the user clicks to select the corresponding property, which is then added to the property dashboard, which is illustrated in FIG. 5C.

A user interface 500C illustrated in FIG. 5C displays the results of the available property query along with a property dashboard 522. The user interface 500C includes many of the same features as the user interface 500B, but also includes the property dashboard 522. The property dashboard 522 lists each property that the user selected from the results 512. In this example, the user has selected “Apartments_B,” “Apartments_C,” “Apartments_D,” and “Apartments_M.” The user can remove a property from the dashboard by selecting a remove button, such as removing Apartment_B from the dashboard by clicking the button 518 for the property listing 514.

The property dashboard 522 enables a user to specify which properties to apply to, which is illustrated in a user interface 500D in FIG. 5D. The property dashboard 522 allows the user to mark or check which properties to apply for pre-approval for, such as by clicking on a check box 524. After the user has checked one or more properties in the property dashboard 522, the user can select an apply button 526 to submit an application for the checked properties. In some implementations, the user can remove properties from the property dashboard 522 by checking a property and clicking the remove button 520.

Clicking on the apply button 526 opens another user interface 500E shown in FIG. 5E. The user interface 500E includes a plurality of text boxes 528 in which the user can provide personal information to be used in the screening requests. Once the user provides all pertinent personal information, the user clicks an apply button 530. The user interface 500E can include other buttons, such as a button to return to the search results, remove properties from the dashboard, etc.

After the user clicks on the apply button 526, the system generates an application for the checked properties in the property dashboard. The system obtains from third party sources (e.g., credit reporting companies or agencies, state or federal criminal records departments, or other personal history metric entities) additional screening information (e.g., credit scores, criminal records, or other personal history information) for the user. The system locally screens the user by comparing the screening information with the specific requirements for each checked property. In some implementations, if the property requires the use of a third party screening company, the system provides one or more screening requests to one or more property-selected screening companies for processing, as described herein. The screening results are displayed to the user in a user interface 500F of FIG. 5F.

The user interface 500F may list each of the properties that the user applied to (information 532) and each property that the user is approved for (information 534) or conditionally approved for (information 536). Along with the results is an approval number 538 to provide to the properties when the user visits a property. As illustrated, the user interface 500F can also include the property dashboard 522 so that the user can quickly apply to additional properties without going back to the search results page. The user can, however, return to the search results page to add additional properties to the property dashboard.

As described above, the process 200 in FIG. 2 describes a user of the system as a person who is looking for pre-approval to rent an apartment before ever going to that property. In some situations, however, this potential renter may decide to visit a particular property to inquire about available units before being pre-approved. The following is an alternative use of the system described herein, where a leasing agent of a particular property utilizes the system to determine if a potential renter is pre-approved for a unit at that particular property or to pre-approve the potential renter for other properties that are affiliated with the particular property.

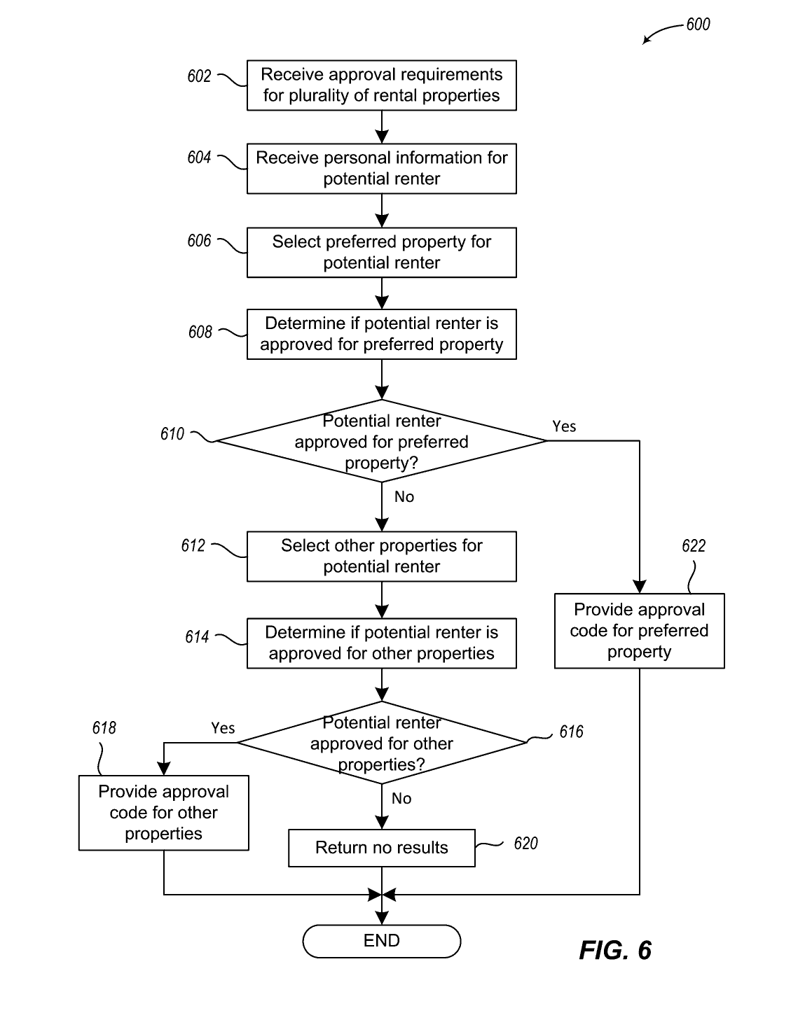

FIG. 6 is a logical flow diagram that illustrates one implementation of an alternative process for recommending other properties for which a potential renter is pre-approved. A process 600 begins at block 602, where approval requirements are received for a plurality of rental properties that have available units for rent. These rental properties may be affiliated with one another, owned by a common company, part of a conglomerate of properties in a common portfolio, or otherwise agree to share information about units they a have available and refer potential renters to each other. Each separate property provides a specific list of requirements, which can be different from one property to another, and which may vary from one unit to another in a particular property. These requirements are often the contents of a rental application for the property. Example requirements may include a minimum credit score, a minimum monthly income, no criminal record, etc. Requirements can be verified through a variety of checking mechanisms, including background checks, credit checks, or other techniques to verify and approve an applicant. In some implementations, this collection of approval requirements may occur prior to a potential renter ever visiting one of the properties.

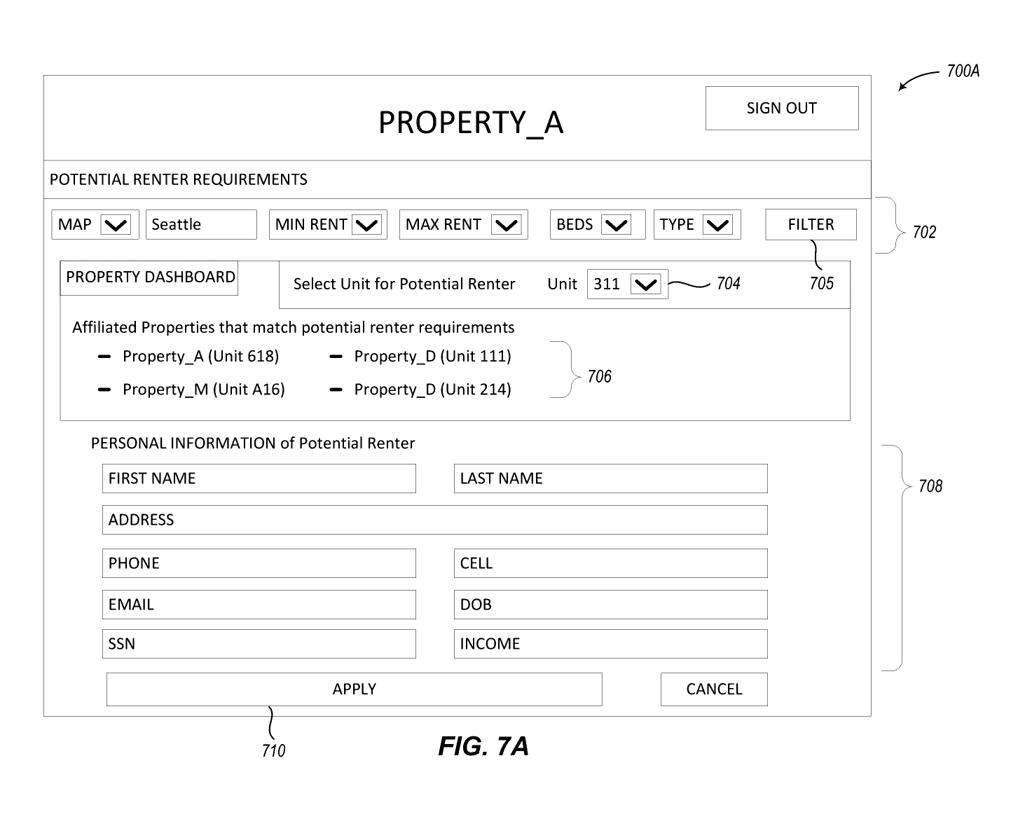

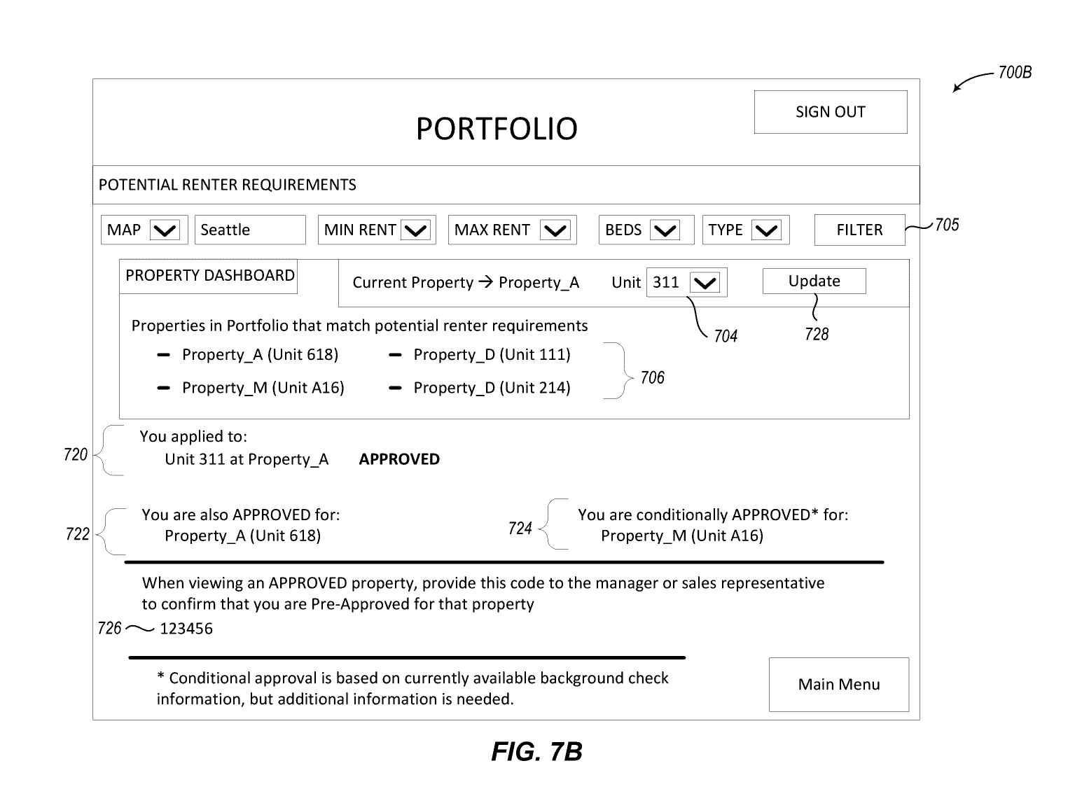

The process 600 proceeds to block 604, where personal information of a potential renter is received. A user (e.g., a leasing agent of the particular property or the potential renter) can enter this information through a user interface, such as illustrated in FIGS. 7A and 7B. The personal information includes information that may be needed for different screening processes for different available properties based on the approval requirements provided by the properties. In various implementations, the potential renter is a person who is visiting or looking at renting an apartment from one of the properties described in block 602.

The process 600 continues at block 606, where a preferred property for the potential renter is determine or otherwise selected. If the system is being utilized by a leasing agent, then the preferred property may be the particular property that the leasing agent is working for or the potential renter is looking at. The preferred property may also include a preferred unit in which the potential renter is interested.

The process 600 proceeds to block 608 to determine if the potential renter is approved for the preferred property. In various implementations, block 608 may be performed utilizing aspects described in conjunction with FIG. 3. Briefly, however, an application is generated from the personal information received for the potential renter. The system obtains other screening information as needed to complete the screening process and returns screening results for the preferred property.

The process 600 continues at decision block 610, where a determination is made as to whether the potential renter is approved for the preferred property based on the screening results from block 608. If the potential renter is approved for the preferred property, then the process 600 flows to block 622; otherwise, the process 600 flows to block 612. At block 622, an approval code for the preferred property is provided to the user, which provides the code to the potential renter. This code is used by the property to verify that the potential renter is approved to rent from that particular property, which is discussed in more detail above in conjunction with FIG. 4. After block 622 the process 600 terminates or otherwise returns to a calling process to perform other actions.

In some implementations, if the user is pre-approved for the preferred property, then the system returns only the results for that pre-approval and does not return a list of other affiliated properties for which the user is pre-approved. In other implementations, even if the potential renter is approved for the preferred property, then the process 600 may proceed (not illustrated) to block 612 to determine if the potential renter is approved for other properties that are affiliated with the preferred property. In this way, the leasing agent can recommend other affiliated properties for which the potential renter is pre-approved, such as if the potential renter decides to not rent the preferred property.

If the potential renter is not approved for the preferred property at decision block 610, then the process 600 flows from the decision block 610 to block 612. At block 612, other properties are selected for the potential renter. These other properties are the affiliated properties identifies in block 602. In some implementations, the affiliated properties may be filtered to those properties with available units that match rental requirements (e.g., minimum or maximum rent, number of bedrooms, geographic location, amenities, etc.) provided by the potential renter.

The process 600 proceeds next to block 614 to determine if the potential renter is approved for the other selected properties. In various implementations, block 614 may be performed utilizing aspects described in conjunction with FIG. 3. Briefly, however, an application is generated from the personal information received for the potential renter. The system obtains other screening information as needed to complete the screening process and returns screening results for the preferred property. In various implementations, much of this screening information was previously obtained at block 608.

The process 600 continues at decision block 616, where a determination is made as to whether the potential renter is approved for the other selected properties based on the screening results from block 614. If the potential renter is approved for one or more of the other selected properties, then the process 600 flows to block 618; otherwise, the process 600 flows to block 620.

At block 618, a list of the other selected properties for which the potential renter is approved or conditionally approved is displayed to the user. Along with this list is an approval code for the other selected properties that the potential renter is approved. The user can then recommend these other selected properties to the potential user and provide the approval code to the potential renter. This code is used by the other selected properties to verify that the potential renter is pre-approved to rent from that respective property, which is discussed in more detail above in conjunction with FIG. 4.

As described above, the user interface can have shared access to a calendar with the affiliated properties and show availability to the user. The user can select an appointment time on behalf of the potential renter, which is then synchronized on the property calendar by populating the property calendar with the selected appointment time. By synchronizing the property calendar with the user interface, the potential renter is provided real-time scheduling access to pre-approved properties, which allows the potential renter to schedule appointments at the recommended properties for which they are pre-approved.

After block 618 the process 600 terminates or otherwise returns to a calling process to perform other actions.

If the potential renter is not approved for any of the other selected properties at decision block 616, then the process 600 flows from decision block 616 to block 620. At block 620, no results are returned to the user and the process 600 terminates or otherwise returns to a calling process to perform other actions.

FIGS. 7A-7B illustrate different example use case screen shots of a user interface provided by a system that recommends other properties for which a potential renter is pre-approved in accordance with the present disclosure. A user interface 700A illustrated in FIG. 7A and a user interface 700B illustrated in FIG. 7B enable a user to determine if a potential renter is pre-approved to rent a specific apartment or unit at a particular property, determine if the potential renter is pre-approved for other properties that are affiliated with or in the same portfolio as the particular property, and recommend those properties to the potential renter.

In these examples, the illustrated user interfaces are specific for a particular property, such as “Property_A,” or a specific portfolio or affiliated properties. The user of the system is a property manager or leasing agent of the particular property and is assisting a potential renter in finding a rental unit. The system may be secure such that only authorized users of the particular property can use the system. The user can log into the system by entering their authorization credentials, not illustrated. Once logged in, the user can utilize the system to find out if the potential renter is pre-approved for one or more rental units at the particular property. In some implementations, the property may have a computer or kiosk available where a potential renter is the user and can use the system in the same way as the leasing agent.

The user interface 700A in FIG. 7A includes a plurality of inputs 702, where the user (e.g., leasing agent) can input a potential renter's apartment requirements, such as minimum and maximum amount of rent, number of bedrooms, or other features that the potential renter would like in an apartment. Once these requirements are added, the user can click button 705 to search for affiliated properties that match the potential renter's requirements.

After button 705 is activated, the system accesses a database of related or affiliated properties to determine which properties have available units that match the potential renter's requirements. In some implementations, the user interface 700A displays a plurality of results 706 to the user. Each property listing in the results 706 may include a variety of different information regarding that related property, such as the name, unit available, how it is affiliated with the particular property of the user, etc. In some implementations, this information may only be available to the leasing agent and not to the potential renter.

The user interface 700A also includes a plurality of text boxes 708 in which the user can provide personal information of the potential renter to be used in screening requests for the potential renter. Once the user provides all pertinent personal information, the user clicks an apply button 710. After the user clicks on the apply button 710, the system generates an application for the unit selected at input 704 and each determined affiliated property in the results 706. The system obtains from third party sources (e.g., credit reporting companies or agencies, state or federal criminal records departments, or other personal history metric entities) additional screening information (e.g., credit scores, criminal records, or other personal history information) for the potential renter. The system locally screens the potential renter by comparing the screening information with the specific requirements for each property. In some implementations, if the property requires the use of a third party screening company, the system provides one or more screening requests to one or more property-selected screening companies for processing, as described herein. The screening results are displayed to the user in a user interface 700B of FIG. 7B.

The user interface 700B may list the preferred or specific unit that the potential renter applied to in information 720. Along with the preferred unit, the information 720 identifies whether the potential renter is approved, not approved, or conditionally approved for that unit. The user interface 700B also lists other affiliated properties that the potential renter is approved for (information 722) or conditionally approved for (information 724). In some implementations, if the potential renter is approved for the preferred unit, then the user interface 700B may not list any properties in information 722 or 724, even if there are affiliated properties that the potential renter is approved or conditionally approved. In this way, the potential renter is more likely to rent from the particular property. In contrast, if the potential renter is not approved for the preferred unit, then the user interface 700B identifies the affiliated properties that the potential renter is approved or conditionally approved in information 722 or 724, respectively. In other implementations, the user interface 700B identifies the affiliated properties that the potential renter is approved or conditionally approved in information 722 or 724 regardless of whether the potential renter is approved or not approved for the preferred unit.

Along with the results is an approval number 726, which is the approval code to provide to the other properties when the user visits a property. As illustrated, the user interface 700B can also include the property dashboard so that the user can quickly see the affiliated properties that match the potential renter's requirements. The user can modify the potential renter's requirements and click the button 705 to update the results 706. Similarly, the user can change the preferred unit with input 704. After the preferred unit is changed or new affiliated properties are identified, the user can click button 728 to apply to these properties. The user may also return to a main menu to search for other units for other potential renters.

FIG. 8 is a system diagram of an implementation of a computing system 800 that includes a server computing device 802 and a client computing device 850 coupled to the server computing device 802. The server computing device 802 is utilized to perform various aspects described herein for the pre-approval aggregator, the screening companies, or other systems. The client computing device 850 is utilized by users or property representatives to access the pre-approval aggregator system.

One or more general-purpose or special-purpose computing systems may be used to implement the server computing device 802, to enable a user to apply for multiple properties prior to visiting the properties as described herein. Accordingly, various implementations described herein may be implemented in software, hardware, firmware, or in some combination thereof.

The server computing device 802 includes a memory 804, one or more central processing units (CPUs) 816, a display device 818, other I/O devices 820, other computer-readable media 822, and network connections 824 (configured to communicate with other computing devices via a wired or wireless communication network). The other I/O devices 820 can include a keyboard, audio interfaces, video interfaces, or the like.

The memory 804 utilizes one or more various types of non-volatile or volatile storage technologies. Examples of the memory 804 include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. The memory 804 is utilized to store information, including computer-readable instructions that are utilized by the CPU 816 to perform actions, including aspects, implementations, and features described herein.

The memory 804 has stored thereon a pre-approval aggregator system 806 or a screening system 808. The pre-approval aggregator system 806 performs various functions described herein to aggregate results from multiple property screenings and to provide pre-approval information to a user. The screening system 808 performs various functions for determining if a user is approved for a property based on personal information of the user and requirements of the property. The memory 804 may also store other programs 812, user data 814 (to store personal information or search histories for users), or an available property database 815 (to store information regarding rental properties that have available units for rent).

The client computing device 850 may be implemented by one or more general-purpose or special-purpose computing systems employing software, hardware, firmware, or some combination thereof. Accordingly, these devices and system include a memory 852, a CPU 866, a display 868, other computer readable media 872, other I/O devices 870, and network connections 874, which may be similar to those same components described above for the server computing device 802. The memory 852 may store instructions for a various computer applications, such as a browser 854 or other programs 856. The memory 852 may also store other data 858.

The server computing device 802 and the client computing device 850 may communicate with each other via communication network 830, which may be one or more of a variety of different wired or wireless communication networks.

The various implementations described above can be combined to provide further implementations. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the implementations can be modified, if necessary to employ concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A method, comprising:
querying a database for a plurality of available rental properties that match search criteria provided by a user;
displaying the plurality of available rental properties to the user;
enabling the user to select one or more of the plurality of available rental properties;
receiving multiple property selections from the user;
generating separate screening requests for each of the multiple selected properties based on personal information provided by the user and approval requirements specific to each selected property;
providing each separate screening request to a screening company along with a unique identifier for the user such that the screening company performs only one credit check on the user for a given period of time for the multiple selected properties;
receiving, from the screening company, a report of whether the user is approved or not approved for each of the multiple selected properties;
providing, to the user, a list of the multiple selected properties for which the user is approved along with an approval code;
receiving the approval code from a property-of-interest for the user, wherein the property-of-interest is one of the plurality of available properties that the user is looking to rent;
if the approval code is valid for the property-of-interest, providing an indication to the property-of-interest that the user is approved for the property-of-interest; and
if the approval code is not valid for the property-of-interest, providing another indication to the property-of-interest that the user is not approved for the property-of-interest.

2. The method of claim 1, further comprising:
determining a screening company for each of the multiple selected properties based on the approval requirements specific to each selected property; and
providing each separate screening request to the screening company determined for the selected property that corresponds to each separate screening request.

3. The method of claim 1, further comprising:
receiving an instruction from the property-of-interest that the user is moving in;
generating and prepopulating rental documents specific to the property-of-interest based on the personal information provided by the user; and
providing the rental documents to the property-of-interest.

4. A method, comprising:
receiving, for a potential renter, search criteria for available properties that are affiliated with a preferred property that the potential renter is visiting;
querying a database of affiliated properties for a plurality of available properties that match the search criteria;
generating separate screening requests for the preferred property and each of the plurality of available properties based on personal information provided for the potential renter and approval requirements specific to each property;
executing each separate screening request by comparing the personal information provided and the approval requirements of each respective property; and
providing a report of whether the potential renter is approved or not approved for the preferred property and a list of the plurality of available properties that the potential renter is approved along with an approval code.

5. The method of claim 4, further comprising:
receiving the approval code from a property-of-interest for the user, wherein the property-of-interest is one of the plurality of available properties;
if the approval code is valid for the property-of-interest, providing an indication to the property-of-interest that the user is approved for the property-of-interest; and
if the approval code is not valid for the property-of-interest, providing another indication to the property-of-interest that the user is not approved for the property-of-interest.

6. A system, comprising:
a screening computing system, including
a first memory that stores first instructions; and
a first processor that executes the first instructions to perform actions, comprising:
determining whether a user is approved or not approved for each of a plurality of selected properties based on a separate screening request for each of the plurality of selected properties; and
generating a report of approved properties that identifies whether the user is approved or not approved for each of the plurality of selected properties; and
a pre-approval aggregator computing system;
a second memory that stores second instructions; and
a second processor that executes the second instructions to perform actions, comprising:
providing a plurality of available rental properties to the user based on search criteria provided by the user;
receiving, from the user, the plurality of selected properties that were selected by the user from the plurality of available rental properties;
generating the separate screening requests for each of the plurality of selected properties based on personal information provided by the user and approval requirements specific to each of the plurality of selected properties;
querying the screening computing system for the report of approved properties based on the separate screening requests;
providing, to the user, a list of the plurality of selected properties for which the user is approved along with an approval code;
receiving the approval code from a property-of-interest for the user, wherein the property-of-interest is one of the plurality of available rental properties that the user is looking to rent; and
providing an indication to the property-of-interest identifying whether the user is approved for the property-of-interest based on a validity of the approval code.

7. The system of claim 6, wherein the second processor of the pre-approval aggregator computing system executes the second instructions to perform further actions, the further actions comprising:
receiving an instruction from the property-of-interest that the user is moving in;
generating and prepopulating rental documents specific to the property-of-interest based on the personal information provided by the user; and
providing the rental documents to the property-of-interest.

8. The system of claim 6, wherein the list of the plurality of selected properties for which the user is approved identifies those properties that the user is outright approved for and those properties that the user is conditionally approved for dependent on additional screening results.
